(19) United States
(12) Patent Application Publication
(10) Pub. No.: US 2012/0128965 A1
(43) Pub. Date: May 24, 2012

(54) MESOPOROUS FILM AND METHOD OF PRODUCING MESOPOROUS FILM

(75) Inventor: Wataru Kubo, Inagi-shi (JP)

(73) Assignee: CANON KABUSHIKI KAISHA, Tokyo (JP)

(21) Appl. No.: 13/295,952

(22) Filed: Nov. 14, 2011

(30) Foreign Application Priority Data
Nov. 22, 2010 (JP) 2010-260529

(51) Int. Cl. B32B 3/26; B01F 17/00; B82Y 30/00; B82Y 40/00

(52) U.S. Cl. 428/312.6; 516/12; 428/304.4; 977/780; 977/895

(57) ABSTRACT

A method of producing a mesoporous film includes a step of preparing a mesostructured film containing a surfactant and an inorganic oxide; a step of holding the mesostructured film in an atmosphere containing a compound having the following formula; and a step of removing the surfactant from the mesostructured film during and/or subsequently to the holding step:

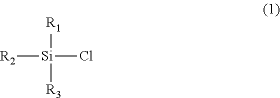

wherein R₁, R₂, and R₃ independently represent an alkyl group containing ten or less carbon atoms.

### BACKGROUND OF THE INVENTION

1. Field of the Invention

The present invention relates to a mesoporous film and a method of producing the mesoporous film.

2. Description of the Related Art

Mesoporous materials with a pore size of 2 nm to 50 nm have features such as high specific surface area, low dielectric constant, and low refractive index and therefore are expected to be widely used in optical and electric applications. A mesoporous film is a form important in making use of various optical and electric properties of the mesoporous materials. A common method of producing the mesoporous film is as follows: a mesostructured film is produced by hydrolytically polycondensing a precursor of an oxide using a surfactant as a template and the template is then removed. A sol-gel process is one of methods of producing the mesostructured film and is widely used to readily produce a high-quality film. However, a film prepared by the sol-gel process shrinks when a template is removed from the film. In particular, a mesostructured film formed on a substrate has a surface fixed on the substrate and therefore does not usually shrink in the in-plane direction of the substrate unless this mesostructured film has cracks or the like. Therefore, this mesostructured film shrinks in the thickness direction thereof; hence, when this mesostructured film has a periodic structure, the periodicity of the periodic structure is reduced. The shrinkage of this mesostructured film adversely affects properties, such as high specific surface area, low dielectric constant, and low refractive index, owned by a mesoporous film prepared from this mesostructured film. Therefore, techniques for preventing such shrinkage have been developed and reported.

Colloids and Surfaces A, 318, 87-87 (2008) (hereinafter referred to as Non-patent Document 1) discloses a technique in which the shrinkage of a mesostructured film is prevented by treating the mesostructured film with an alkoxide.

However, the mesostructured film produced by the technique disclosed in Non-patent Document 1 is not sufficiently prevented from shrinking because it has been confirmed that the mesostructured film shrinks in the thickness direction thereof, the structural period of the mesostructured film is reduced in the thickness direction thereof, and the structural regularity thereof is reduced as compared with the mesostructured film unseparated from a template. Therefore, shrinkage-preventing techniques need to be improved.

### SUMMARY OF THE INVENTION

The present invention provides a method of producing a mesoporous film, the method being capable of reducing the shrinkage of a mesostructured film that is caused by the removal of a template.

A method of producing a mesoporous film according to an aspect of the present invention includes a step of preparing a mesostructured film containing a surfactant and an inorganic oxide, a step of holding the mesostructured film in an atmosphere containing a compound having the following formula, and a step of removing the surfactant from the mesostructured film during and/or subsequently to the holding step:

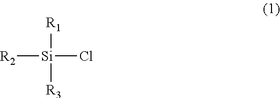

wherein R₁, R₂, and R₃ independently represent an alkyl group containing ten or less carbon atoms.

Further features of the present invention will become apparent from the following description of exemplary embodiments with reference to the attached drawings.

### BRIEF DESCRIPTION OF THE DRAWINGS

FIG. 1 is a flowchart showing steps of a method of producing a mesoporous film according to a first embodiment of the present invention.

FIG. 2 is a schematic view of cylinders in circumferential cross section.

FIG. 3 is a schematic view obtained from a two-dimensional X-ray diffraction image of a mesostructured film.

FIG. 4 is a graph comparing samples prepared in Example 1.

FIG. 5 is a graph comparing measurement results obtained in Example 1.

FIG. 6 is a graph comparing samples prepared in Example 3.

FIG. 7 is a graph comparing samples prepared in Example 5.

### DESCRIPTION OF THE EMBODIMENTS

Embodiments of the present invention will now be described in detail. In advance of describing the embodiments, terms common to the embodiments are described below.

### DESCRIPTION OF TERMS

### (1) Mesoporous Film

Porous materials are grouped by International Union of Pure and Applied Chemistry (IUPAC) in accordance with the pore size thereof. Porous materials with a pore size of 2 nm to 50 nm are classified into mesoporous materials. In recent years, the mesoporous materials have been extensively studied. As a result, structures having regularly arranged mesopores uniform in size can be obtained using surfactant clusters as templates.

The term “mesoporous film” as used herein refers to a porous film having pores with a size of 2 nm to 50 nm and a wall portion (that is, a portion other than the pores) made of an oxide.

Among mesoporous films is a mesoporous film with structural regularity. The mesoporous film with structural regularity exhibits properties resulting from the structure thereof, particularly X-ray reflectivity and the like, and can be applied to devices, such as X-ray mirrors, making use of such properties. An example of the mesoporous film with structural regularity is one having a periodic structure. Examples of the periodic structure include a two-dimensional periodic structure and a three-dimensional periodic structure. An example of the two-dimensional periodic structure is a two-dimensional hexagonal structure. Examples of the three-dimensional periodic structure include a three-dimensional hexagonal structure and a cubic structure. An example of the structure of the mesoporous film with structural regularity is a cylindrical honeycomb structure. The cylindrical honeycomb structure is usually described as a two-dimensional hexagonal structure. Some cylindrical structures have an orientation controlled in one direction in the plane of a substrate. Such cylindrical structures controlled in one direction can exhibit anisotropic properties and therefore are useful. One of properties thereof is to impart anisotropy to light-emitting and -absorbing properties of molecules introduced in pores. Mesoporous films can be applied to anisotropic light-emitting devices by making use of such properties.

### (2) Oxide

The term “oxide” as used herein includes both inorganic oxides and substances having inorganic oxide frameworks and containing organic matter located inside or outside the inorganic oxide frameworks. Examples of the inorganic oxides include silicon oxide, tin oxide, zirconium oxide, titanium oxide, niobium oxide, tantalum oxide, aluminum oxide, tungsten oxide, hafnium oxide, and zinc oxide. Examples of the substances, which have the inorganic oxide frameworks and contain organic matter, include those containing an atom (for example, a silicon atom) other than an oxygen atom contained in an inorganic oxide such as silicon oxide and an organic molecule (more properly an organic group) bonded to the atom. Examples of the organic molecule (the organic group) include aromatic groups such as a phenyl group and aliphatic groups such as a methyl group and a methylene group. Examples of precursors of the inorganic oxides include alkoxides and chlorides of silicon and metal elements. Specific examples of the inorganic oxide precursors include alkoxides and chlorides of silicon, tin, zirconium, titanium, niobium, tantalum, aluminum, tungsten, hafnium, and zinc. Examples of the alkoxides include methoxides, ethoxides, propoxides, and alkoxides containing an alkoxy group with an alkyl substituent.

Preferred embodiments of the present invention will now be described in detail with reference to the attached drawings.

### First Embodiment

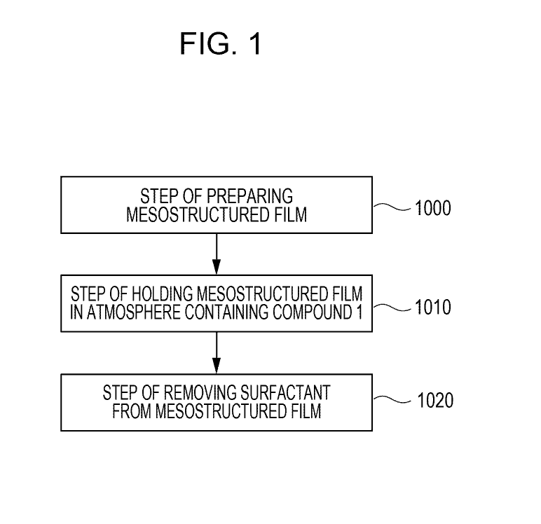

FIG. 1 shows steps of a method of producing a mesoporous film according to a first embodiment of the present invention.

With reference to FIG. 1, reference numeral 1000 represents a step of preparing a mesostructured film, reference numeral 1010 represents a step of holding the mesostructured film in an atmosphere containing Compound 1, and reference numeral 1020 represents a step of removing a surfactant from the mesostructured film.

In this embodiment, after the mesostructured film is held in the atmosphere containing Compound 1, the surfactant, which serves as a template when the mesostructured film is prepared, is removed from the mesostructured film. Therefore, the shrinkage of the mesostructured film can be prevented during the removal of the surfactant.

The method of producing the mesostructured film according to this embodiment is described below in the following order: (1) Sol-gel process, (2) Surfactant, (3) Mesostructured film, (4) Step of holding mesostructured film in atmosphere containing Compound 1, (5) Step of removing surfactant from mesostructured film, (6) Evaluation method, and (7) Effect.

### (1) Sol-Gel Process

In the method of producing the mesoporous film according to this embodiment, a sol-gel process is used. The sol-gel process is one of wet synthesis processes for inorganic materials. In particular, the sol-gel process is as follows: a solution is prepared from a solution of an alkoxide used as a starting material of an inorganic material through a chemical reaction such as hydrolysis or polycondensation and is gelled, followed by drying, sintering, or the like, whereby the inorganic material is obtained. As compared with other processes such as hydrothermal processes, the sol-gel process is more advantageous in that the sol-gel process is simple and takes a short time to prepare a film and the prepared film is uniform and has high structural regularity. However, the sol-gel process has a problem that the shrinkage of an obtained film is large and the structural regularity thereof is reduced due to the shrinkage. In particular, a mesostructured film formed on a substrate has a surface fixed on the substrate and therefore does not usually shrink in the in-plane direction of substrate unless this mesostructured film has cracks or the like. Therefore, this mesostructured film shrinks in the thickness direction thereof; hence, when this mesostructured film has a periodic structure, the periodicity of the periodic structure is reduced. This embodiment relates to the prevention of such shrinkage and the maintenance of structural regularity.

The preparation of the mesoporous film by the sol-gel process is not particularly limited. The mesoporous film can be produced by, for example, the following procedure: a solution containing the surfactant and a precursor of a material for forming a wall portion is prepared; the production reaction of the material for forming the wall portion and the self-assembly reaction of the surfactant are caused prior or subsequently to the evaporation of a solvent; and the surfactant, which serves as a template, is then removed, whereby the mesoporous film is produced.

The solvent is contained in the solution containing the precursor and can dissolve the precursor and the surfactant. An example of the solvent is an organic solvent. An example of the organic solvent is a polar solvent. Examples of the polar solvent include tetrahydrofuran and alcohols such as ethanol, propanol, methanol, and butanol.

The solution may contain another substance as required. The solution may contain, for example, a substance for adjusting the acidity or basicity of a reaction solution having a catalytic function. Examples of the substance for adjusting the acidity or basicity thereof include acids such as hydrochloric acid and bases such as ammonium hydroxide. The substance is usually used to control the hydrolysis rate or polycondensation rate of precursors.

Examples of a film-forming method using the sol-gel process include a dip coating process, a spin coating process, and a casting process. The surfactant and the surfactant-removing step are described below.

### (2) Surfactant

An example of the surfactant used is an ionic or nonionic surfactant. An example of the ionic surfactant is an alkyltrimethyl ammonium halide, which usually has an alkyl chain length of ten to 22 carbon atoms. An example of the nonionic surfactant is a block copolymer having a hydrophilic segment and a hydrophobic segment. An example of the hydrophilic segment is a polyethylene glycol group. Examples of the hydrophobic segment include alkyl chains including branched chains, polypropylene glycol chains, polystyrene chains, polybutadiene chains, and polymethyl methacrylate chains. Specific examples of a surfactant having a hydrophilic polyethylene glycol chain include polyethylene glycol alkyl ethers and polyethylene glycol-polypropylene glycol-polyethylene glycol block copolymers. When the polyethylene glycol alkyl ethers are linear, the polyethylene glycol alkyl ethers have an alkyl chain length of, for example, ten to 22 carbon atoms and the number of polyethylene glycol repeating units is, for example, two to 50. The structural period of the mesostructure and mesoporous films can be varied by modifying a hydrophobic group (hydrophobic segment) or hydrophilic group (hydrophilic segment) of the surfactant. In general, the pore size and structural period thereof can be increased by enlarging the hydrophobic or hydrophilic group. An additive for adjusting the structural period may be used in addition to the surfactant. An example of the additive is a hydrophobic substance. Examples of the additive include alkanes and aromatic compounds containing no hydrophilic group. A specific example of the additive is octane or the like.

### (3) Mesostructured Film

The term “mesostructured film” as used herein refers to a mesoporous film having pores filled with mainly a surfactant. The mesostructured film is described below in detail.

A material for forming the wall portion may be one described in Section “(1) Mesoporous film”. A substance filled in pores of the mesoporous film is not particularly limited and may be one mainly containing the surfactant. The term “mainly” as used herein means that the volume percentage is 50% or more. The pores may contain water, an organic solvent, a salt, and the like as required or as a result of a material used or a step. Examples of the organic solvent include alcohols, ethers, and hydrocarbons.

### (4) Step of Holding Mesostructured Film in Atmosphere Containing Compound 1

### (4-1) Compound

Compound 1 has the following formula:

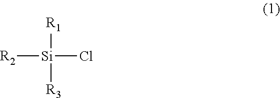

wherein R₁, R₂, and R₃ independently represent an alkyl group containing ten or less carbon atoms. The fact that the number of carbon atoms in the alkyl group is ten or less is advantageous in supplying Compound 1 into the mesostructured film. In particular, in the case of introducing Compound 1 in a gas phase mode, the mesostructured film is preferably heated in order to supply Compound 1 to the mesostructured film and in order to promote the reaction of Compound 1 with a silanol group. The heating of the mesostructured film also promotes the condensation of unreacted silanol groups remaining in the mesostructured film. Therefore, the mesostructured film is preferably heated to a low temperature such that the supply of Compound 1 is not prevented. In this regard, the alkyl group is advantageous because the alkyl group contains ten or less carbon atoms and therefore is evaporated at a lower temperature as compared with those containing more than ten carbon atoms.

It is preferable that R₁ is an alkyl group containing ten or less carbon atoms and R₂ and R₃ are methyl groups. It is more preferable that all R₁, R₂, and R₃ are methyl groups.

### (4-2) Holding Technique

A technique of holding the mesostructured film in the atmosphere containing Compound 1 is not particularly limited. Examples of the holding technique include a technique of exposing the mesostructured film to vaporized Compound 1 and a technique of immersing the mesostructured film in a solution containing Compound 1. The expression “holding the mesostructured film in the atmosphere containing Compound 1” as used herein includes, for example, exposing the mesostructured film to vaporized Compound 1 and immersing the mesostructured film in such a solution containing Compound 1 and means that Compound 1 is applied to the mesostructured film by any technique. In particular, the following technique is preferably used: a technique in which the mesostructured film is exposed to the vapor of Compound 1 in such a manner that the mesostructured film and Compound 1 are held in a sealed vessel and the sealed vessel is heated. This technique has an advantage that the mesostructured film is hardly dissolved in Compound 1 and an advantage that the amount of deposits on the obtained mesoporous film is small.

(4-3) Holding conditions

Conditions for holding the mesostructured film in the atmosphere containing Compound 1 are as described below.

The holding temperature of the mesostructured film is preferably 10° C. to 220° C., more preferably 10° C. to 180° C., and further more preferably 40° C. to 140° C.

The holding time of the mesostructured film is preferably 1 s to 60 h and more preferably 6 h to 24 h.

The amount of a reagent such as Compound 1 can be optimized depending on the type of a reagent such as Compound 1, a vessel used for treatment, and the surface area of the mesostructured film and may be, for example, 0.01 mL to 10 mL in the case of using a 180-mL vessel.

The mesostructured film may be treated in another way before or after the step of holding the mesostructured film in the atmosphere containing Compound 1. For example, the mesostructured film may be heated or may be treated with an acid, a base, or a reagent. An example of the reagent is an alkoxide.

(5) Step of Removing Surfactant from Mesostructured Film

In the surfactant-removing step, a solvent extraction technique or a decomposition removal technique can be used. Examples of the solvent extraction technique include techniques using solvents or supercritical fluids. Examples of the decomposition removal technique include heating, firing, UV irradiation, and O₃ treatment. The solvent extraction technique is milder than the decomposition removal technique and is useful in preventing shrinkage and the reduction of structural regularity due to shrinkage. The decomposition removal technique is more useful in reducing the amount of the remaining surfactant as compared with the solvent extraction technique. In particular, the extraction of the surfactant with a solvent is easy in process, is capable of preventing shrinkage and the reduction (variation) of structural regularity due to shrinkage, and therefore is preferably used. Examples of the solvent include solvents capable of dissolving the surfactant. Specific examples of the solvent include alcohol, tetrahydrofuran, and chloroform. A mixture of two or more solvents may be used as required. The solvent may be mixed with a substance such as an acid, a base, or a silane coupling agent for the purpose of assisting extraction.

The surfactant-removing step may be performed in the step (or during the step) of holding the mesostructured film in the atmosphere containing Compound 1 described in Section (4) instead of performing the step of holding the mesostructured film in the atmosphere containing Compound 1. The step of holding the mesostructured film in the atmosphere containing Compound 1 may be performed in such a manner that the modification of Compound 1 and the removal of the surfactant are simultaneously carried out by maintaining the mesostructured film is maintained at a temperature at which the surfactant is decomposed or desorbed.

### (6) Evaluation Method

The mesostructured film can be evaluated by transmission electron microscope observation, scanning electron microscope observation, atomic force microscope observation, X-ray diffraction (XRD) analysis, infrared (IR) absorption spectroscopy, ultraviolet-visible absorption spectroscopy, fluorescence spectroscopy, X-ray photoelectron spectroscopy, surface roughness measurement, or the like.

Whether a film prepared by the producing method according to this embodiment is porous can be checked by transmission electron microscope observation, scanning electron microscope observation, or atomic force microscope observation.

The structural regularity of the mesoporous film can be determined by XRD analysis. The structural period of the mesostructure and mesoporous films in the thickness direction can be identified in such a manner that, for example, XRD analysis is performed using Bragg-Brentano geometry and the interplanar spacing corresponding to the angle giving a diffraction peak is calculated.

The relationship between the angle, the interplanar spacing, and the wavelength of an X-ray used is given by the Bragg equation nλ=2d sin θ. For example, in the case of using the Cu-Kα line at a wavelength of 0.1542 nm for measurement, the presence of a diffraction peak at θ=1° indicates that the interplanar spacing is 4.42 nm and the presence of a diffraction peak at θ=2° indicates that the interplanar spacing is 2.21 nm. The terms “mesostructured film with structural regularity” and “mesoporous film with structural regularity” as used herein mean any film having at least one diffraction peak at an angle corresponding to an interplanar spacing of more than 1 nm.

Whether the mesoporous film, which is prepared by the producing method according to this embodiment and has structural regularity, has a cylindrical honeycomb structure can be determined by XRD analysis. The cylindrical honeycomb structure can be identified in such a manner that, for example, a two-dimensional X-ray diffraction pattern is obtained from the mesoporous film, (01) spots are added to this pattern, and whether (10) and (−11) spots characteristic of the cylindrical honeycomb structure appear is checked. Alternatively, the cylindrical honeycomb structure can be identified by the microscopic observation of a cross section of the mesoporous film.

In this embodiment, the shrinkage of the mesoporous film, particularly the shrinkage in the thickness direction thereof, can be evaluated by, for example, the following method:

(i) the comparison between the thickness of the mesostructured film before the surfactant-removing step and the thickness of the mesostructured film after the surfactant-removing step or

(ii) the comparison between the structural period of the mesostructured film before the surfactant-removing step and the structural period of the mesostructured film after the surfactant-removing step when the mesoporous film has structural regularity.

In this embodiment, the degree of the structural regularity of the mesoporous film can be evaluated using, for example, the following item:

(i) the half-width of a Bragg reflection peak in an X-ray diffraction profile in Bragg-Brentano geometry (the narrower the half-width is, the higher the structural regularity is) or

(ii) the distribution of reflected intensity by reciprocal lattice space mapping (the narrower the distribution is, the higher the structural regularity is).

The degree of the modification of the mesostructure or mesoporous film with Compound 1 can be determined by IR analysis. In this case, signals observed at the following wavenumbers can be used: a wavenumber of 3,150 cm⁻¹ to 2,750 cm⁻¹, which corresponds to a hydroxyl group, a wavenumber of 1,259 cm⁻¹, which corresponds to a trimethylsilyl group, and a wavenumber of 845 cm⁻¹, which corresponds to a trimethylsilyl group.

### (7) Effect

In the method of producing the mesoporous film according to this embodiment, after the mesostructured film is held in the atmosphere containing Compound 1, which is a halide of a trialkylsilane, the surfactant is removed from the mesostructured film; hence, the shrinkage of the mesostructured film can be prevented and the structural regularity of the mesoporous film can be maintained high. This mechanism is described below on the basis of the consideration of the inventors.

In the step of removing the surfactant from the mesostructured film, clusters of the surfactant that support the structure of the mesostructured film are removed from the mesostructured film. In this step, many hydroxyl groups (silanol groups (Si—OH)) remain on silica walls making up the mesostructured film. In the presence of the surfactant, the reaction of silanol groups is chemically and spatially prevented. After the surfactant is removed, the silanol groups form Si—O—Si bonds through polycondensation. The reduction of the distance between silicon atoms probably causes the shrinkage of the mesostructured film particularly in the thickness direction. An alkoxide of an alkylsilane that is conventionally used to prevent such shrinkage reacts with the silanol groups to prevent the condensation of the silanol groups, thereby preventing the shrinkage of the mesostructured film. According to studies by the inventors, the effect of reducing the number of the silanol groups with the alkoxide is insufficient. In the present invention, the number of the silanol groups is further reduced using a halide of an alkylsilane that is more reactive with the silanol groups than the alkoxide. The halide is more effective in reducing the number of the silanol groups as compared with the alkoxide. Therefore, the shrinkage of the mesostructured film can be prevented and the reduction in structural regularity of the mesostructured film due to the shrinkage thereof can also be prevented.

### Second Embodiment

A mesoporous film according to a second embodiment of the present invention will now be described in the following order:

(1) Mesoporous film formed on substrate,

(2) X-ray diffraction measurement,

(3) Relationship with angle giving peak, and

(4) Relationship with absorbance in infrared region.

### (1) Mesoporous Film Formed on Substrate

A substrate used in this embodiment is capable of forming the mesoporous film and is not particularly limited. Examples of a material used to form the substrate include silicon, quartz, glass, metal, and polymers. The shape of the substrate is not particularly limited. The substrate may have, for example, a flat shape, a curved shape, or the like.

The mesoporous film may be that described in Section “Description of Terms” and the first embodiment. The mesoporous film is characterized by having a periodic structure that is highly regular in a direction perpendicular to a surface of the substrate. This feature is expressed using a value obtained by X-ray diffraction measurement as described below.

### (2) X-Ray Diffraction Measurement

A feature of the mesoporous film, that is, the periodic structure, which is highly regular in the direction perpendicular to the substrate surface, is expressed using such a value obtained by X-ray diffraction measurement.

The X-ray diffraction measurement of the mesoporous film is performed with an X-ray optical system with Bragg-Brentano geometry. This geometry means geometry in which a diffracted X-ray beam and a surface of a sample form an angle of θ and an incident X-ray beam and the diffracted X-ray beam form an angle of 2θ, wherein θ is the angle between the incident X-ray beam and the sample surface.

The X-ray diffraction measurement thereof is performed using an incident X-ray with a divergence angle of 3.4×10⁻³ degree or less. Such an X-ray can be obtained in such a manner that, for example, the Cu-Kα line is converged with a multilayer mirror and is caused to pass through Ge (220) four-crystal optics. The X-ray diffraction measurement is performed using an optical system with a 2θ resolution of 0.034 degree or less. The resolution thereof is set using, for example, a slit. The reason for limiting the divergence angle and the 2θ resolution is that when the divergence angle and the 2θ resolution are large, the regularity of a fine periodic structure cannot be evaluated. The reason for using the term “or less” to describe the divergence angle and the 2θ resolution is that that when the divergence angle and the 2θ resolution are 3.4×10⁻³ degree or less and 0.034 degree or less, respectively, the regularity of a finer periodic structure cannot be evaluated.

In this embodiment, the mesoporous film has the periodic structure, which is highly regular in the direction perpendicular to the substrate surface, and therefore has a surface which is parallel to the substrate surface and which has a maximum Bragg reflectivity of more than 20% to less than 60%. A method of producing the mesoporous film is not particularly limited. The mesoporous film can be produced by, for example, the producing method according to the first embodiment. Such high Bragg reflectivity is due to the high contrast of the refractive index of pore-wall interfaces obtained in this embodiment and the maintenance of high structural period. The reason why the maximum Bragg reflectivity thereof is less than 60% is that it is difficult to achieve a maximum Bragg reflectivity of 60% or more because of the incompleteness of the structural period of the mesoporous film.

(3) Relationship with Angle Giving Peak

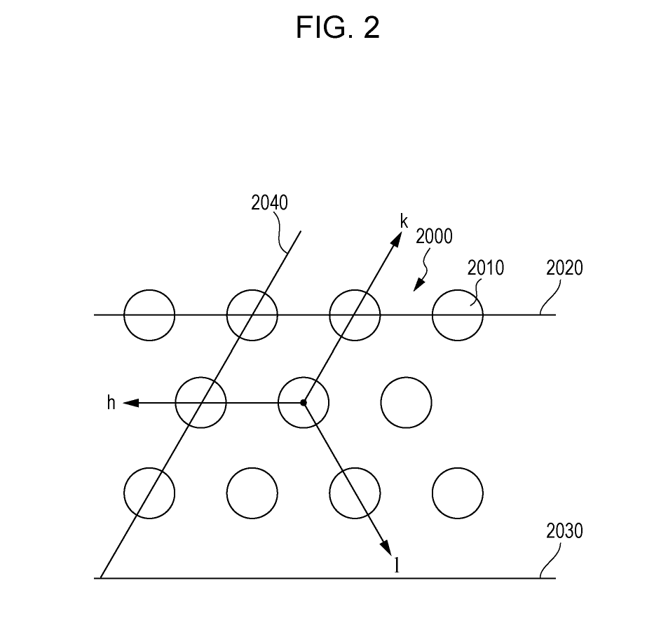

Examples of the periodic structure of the mesoporous film are the periodic structures described in Section “Description of Terms”. A particularly preferred example of the periodic structure is a cylindrical honeycomb structure. FIG. 2 is a schematic view of cylinders, in circumferential cross section, present in the cylindrical honeycomb structure.

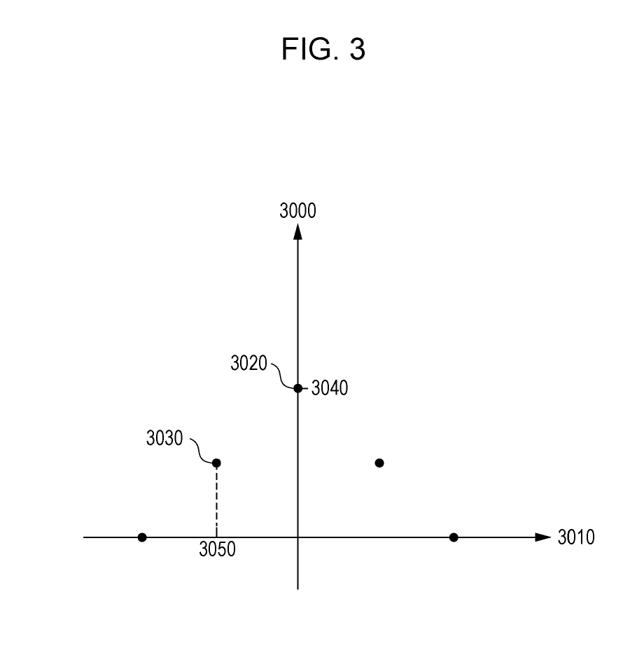

With reference to FIG. 2, reference numeral 2000 represents a silica wall, reference numeral 2010 represents pores, reference numeral 2030 represents the substrate surface, reference numeral 2020 represents a (01) plane perpendicular to the substrate surface 2030, and reference numeral 2040 represents a (10) plane. FIG. 3 is a schematic view obtained from a two-dimensional X-ray diffraction image of a mesostructured film having such a structure. With reference to FIG. 3, reference numeral 3000 represents the out-of-plane direction (2θ direction) of the substrate, reference numeral 3010 represents the in-plane direction (2θₓ direction) of the substrate, reference numeral 3020 represents a Bragg reflection spot due to the (01) plane, reference numeral 3030 represents a Bragg reflection spot due to the (10) plane, reference numeral 3040 represents the peak angle B of Bragg reflection due to the (01) plane in the out-of-plane direction of the substrate, and reference numeral 3050 represents the peak angle A of Bragg reflection due to the (10) plane in the in-plane direction of the substrate.

The absolute value of A/B that characterizes a single structure which the mesoporous film can take is described below. This value is used to express the shrinkage of the mesoporous film, which has the cylindrical honeycomb structure, in the thickness direction thereof. A mesostructured film formed on a substrate usually shrinks during the removal of a template. Since a surface of this mesostructured film is fixed on this substrate, this mesostructured film does not usually shrink in the in-plane direction of this substrate unless this mesostructured film has cracks or the like. Therefore, this mesostructured film shrinks only in the thickness direction of this mesostructured film. In a mesostructured film (before the removal of a template) having a cylindrical honeycomb structure, the absolute value of A/B is usually more than 0.60 to about 0.63 or less (up to 7.0). When this mesostructured film shrinks during the removal of the template, the periodic structure of this mesostructured film does not vary in the in-plane direction thereof but shrinks in the out-of-plane direction thereof. Therefore, the value of A does not vary and the absolute value of B increases. As a result, the shrinkage of a film usually allows the absolute value of A/B to be 0.6 or less. Herein, the fact that the absolute value of A/B is greater than 0.6 means that a film hardly shrinks during the removal of a template. The two-dimensional X-ray diffraction image is measured with a two-dimensional detector in such a manner that the incident angle of an X-ray applied to the mesoporous film is set to, for example, 0.2 degree.

(4) Relationship with Absorbance in Infrared Region

A mesoporous silicon oxide film used in this embodiment is characterized in that the maximum absorbance thereof is 0.08 or more at a wavenumber of 845 cm⁻¹±5 cm⁻¹ as normalized on the basis of the maximum absorbance at a wavenumber of 1,070 cm⁻¹±5 cm⁻¹. In the silicon oxide film, a peak observed at a wavenumber of 1,070 cm⁻¹±5 cm⁻¹ is assigned to Si—O—Si stretching and usually exhibits the largest absorbance and a peak observed at a wavenumber of 845 cm⁻¹±5 cm⁻¹ indicates a locking mode characteristic of a trimethylsilyl group. The absorbance in the infrared region can be determined in such a manner that, for example, a mesoporous film is formed on a double-side polished silicon substrate and is measured for absorbance with a commercially available infrared absorptiometer.

Examples of a method of allowing a peak assigned to a trimethylsilyl group to be present in the infrared absorption spectrum of the silicon oxide film include the following two methods:

(i) a method of performing treatment with a reagent producing a trimethylsilyl group and

(ii) a method of using a material producing a trimethylsilyl group as a source material of the silicon oxide film.

Method (i) allows the silicon oxide film to have a peak characteristic of a trimethylsilyl group. The intensity of an absorption peak observed therein is proportional to the amount of trimethylsilyl groups bonded thereto. In the above-mentioned normalized absorbance, the amount of trimethylsilyl groups that corresponds to a peak intensity of more than 0.08 is obtained only by treatment with trimethylchlorosilane, which is most preferably used in this embodiment, in the case of Method (i). A mesoporous film having such a number of trimethylsilyl groups hardly shrinks during the removal of a template, has high structural period, and provides high Bragg reflection intensity.

Method (ii) allows such a peak characteristic of a trimethylsilyl group to be present in the infrared absorption spectrum of the silicon oxide film. However, a large number of unreacted silanol groups remain on a mesostructured film prepared by this method and therefore cause the shrinkage of this mesostructured film in the thickness direction thereof during the removal of a template. Thus, in the case of creating a peak by Method (ii), the shrinkage of this mesostructured film is not prevented or the relationship between A and B described in Section “(3) Relationship with angle giving peak” is not achieved. Furthermore, in this case, a reduction in structural period is not prevented.

### EXAMPLES

The present invention is further described below in detail with reference to examples. The present invention is not limited to the examples.

The examples are described below in the following order:

(1) Items common to examples,
(1-1) Step of preparing mesostructured film,
(1-2) Reagent-treating step,
(1-3) Template-removing step,
(1-4) Evaluation, and

(2) Examples.

### (1) Items Common to Examples

(1-1) Step of Preparing Mesostructured Film,

(1-1-1) Preparation of Silicon Oxide Mesostructured Film Using Polyethylene Oxide-Polypropylene Oxide-Polyethylene Oxide as Template

### (a) Preparation of Precursor Solution of Mesostructured Film

A silicon oxide mesostructured film with a two-dimensional hexagonal structure was prepared by a dip coating process. A precursor solution of the silicon oxide mesostructured film was prepared in such a manner that an ethanol solution of a block copolymer was added to a solution prepared by mixing ethanol, 0.01 M hydrochloric acid, and tetraethoxysilane for 20 minutes, followed by stirring for three hours. The block copolymer used was Pluronic™ P123 available from BASF. Pluronic™ P123 is polyethylene oxide (20)-polypropylene oxide (70)-polyethylene oxide (20) and is hereinafter referred to as EO(20)PO(70)EO(20), wherein each bracketed value is the number of repeating units in a corresponding one of blocks. Methanol, propanol, 1,4-dioxane, tetrahydrofuran, or acrylonitrile can be used instead of ethanol. The mixing ratio of tetraethoxysilane to hydrochloric acid to ethanol to the block copolymer to ethanol was 1.0:0.0011:5.2:0.0096:3.5 on a molar basis. The precursor solution used was appropriately diluted for the purpose of adjusting the thickness of the silicon oxide mesostructured film.

### (b) Formation of Mesostructured Film

A cleaned substrate was dip-coated at a pulling rate of 0.5-2 mms⁻¹ using a dip coater. An obtained mesostructured film was held at 25° C. for 24 hours in a constant-temperature, constant-humidity bath with a relative humidity of 40%.

(1-1-2) Preparation of Silicon Oxide Mesostructured Film Using Polyethylene Oxide Alkyl Ether as Template

### (a) Preparation of Precursor Solution of Mesostructured Film

A silicon oxide mesostructured film with a two-dimensional hexagonal structure was prepared by a dip coating process. A precursor solution of the silicon oxide mesostructured film was prepared in such a manner that a surfactant, hydrochloric acid, water, an ethanol solution, and tetraethoxysilane were mixed for two hours. The surfactant used was Brij™ 56 available from SIGMA CHEMICAL Co. The mixing ratio of tetraethoxysilane to hydrochloric acid to water to ethanol to the surfactant was 1.0:0.0040:5.0:22:0.080 on a molar basis. The precursor solution used was appropriately diluted for the purpose of adjusting the thickness of the silicon oxide mesostructured film.

### (b) Formation of Mesostructured Film

A cleaned substrate was dip-coated at a pulling rate of 0.5-2 mms⁻¹ using a dip coater. An obtained mesostructured film was held at 25° C. for 24 hours in a constant-temperature, constant-humidity bath with a relative humidity of 40%.

(1-1-3) Preparation of Titanium Oxide Mesostructured Film Using Polyethylene Oxide-Polypropylene Oxide-Polyethylene Oxide as Template

### (a) Preparation of Precursor Solution of Mesostructured Film

A titanium oxide mesostructured film with a two-dimensional hexagonal structure was prepared by a dip coating process. A precursor solution of the titanium oxide mesostructured film was prepared in such a manner that an ethanol solution of the block copolymer EO(20)PO(70)EO(20) was added to a solution prepared by mixing tetraethoxysilane and concentrated hydrochloric acid for five minutes, followed by stirring for three hours. Methanol, propanol, 1,4-dioxane, tetrahydrofuran, or acrylonitrile can be used instead of ethanol. The mixing ratio of tetraethoxysilane to hydrochloric acid to the block copolymer to ethanol was 1.0:1.8:0.021:14 on a molar basis. The precursor solution used was appropriately diluted for the purpose of adjusting the thickness of the titanium oxide mesostructured film.

### (b) Formation of Mesostructured Film

A cleaned substrate was dip-coated at a pulling rate of 0.5-2 mms⁻¹ using a dip coater. In this operation, the temperature was 25° C. and the relative humidity was 40%. An obtained mesostructured film was held at 25° C. for two days in a constant-temperature, constant-humidity bath with a relative humidity of 50%.

(1-2) Reagent Treatment

Reagent treatment was performed in such a manner that a mesostructured film was placed in a 180-mL vessel made of a fluorocarbon resin, 1 mL of a reagent was poured into the vessel, the vessel was sealed and was then maintained at a predetermined temperature for a predetermined time, and the mesostructured film was taken out of the vessel. Reagent treatment can be performed in such a manner that the mesostructured film is dipped in the reagent for one second and is then cleaned with ethanol.

(1-3) Removal of Template

A template was removed in such a manner that a mesostructured film treated with a regent was immersed in a predetermined solvent and was held at 80° C. for two hours. The template can be removed the mesostructured film treated with the regent is fired at 400° C. for ten hours.

(1-4) Evaluation

A prepared film was analyzed by X-ray diffraction using Bragg-Brentano geometry. An incident X-ray with a divergence angle of 3.4×10⁻³ degree was used to obtain an X-ray beam. The 20 resolution was set to 0.034 degree.

A sample used in each example provided a Bragg reflection peak due to a (01) plane parallel to a surface of a substrate. The degree of shrinkage was evaluated using the structural period calculated from the peak value of X-ray Bragg reflection due to the periodic structure.

### (2) Examples

### Example 1

In this example, the influence of the presence or absence of reagent treatment and the difference between treatment reagents on an X-ray reflectivity profile and the cause thereof are considered. Sample conditions are as described below.

Example Sample 1

Mesostructured film: the mesostructured film described in Section (1-1-1)

Treatment reagent: chlorotrimethylsilane

Treatment temperature: 80° C.

Treatment time: 14 hours

Template-removing method: ethanol extraction

Comparative Sample 1

Difference of Comparative Sample 1 from Example Sample 1: the use of methoxytrimethylsilane as a treatment reagent

Comparative Sample 2

Difference of Comparative Sample 2 from Example Sample 1: no reagent treatment, non-heating, or no template removal (the remaining of a surfactant)

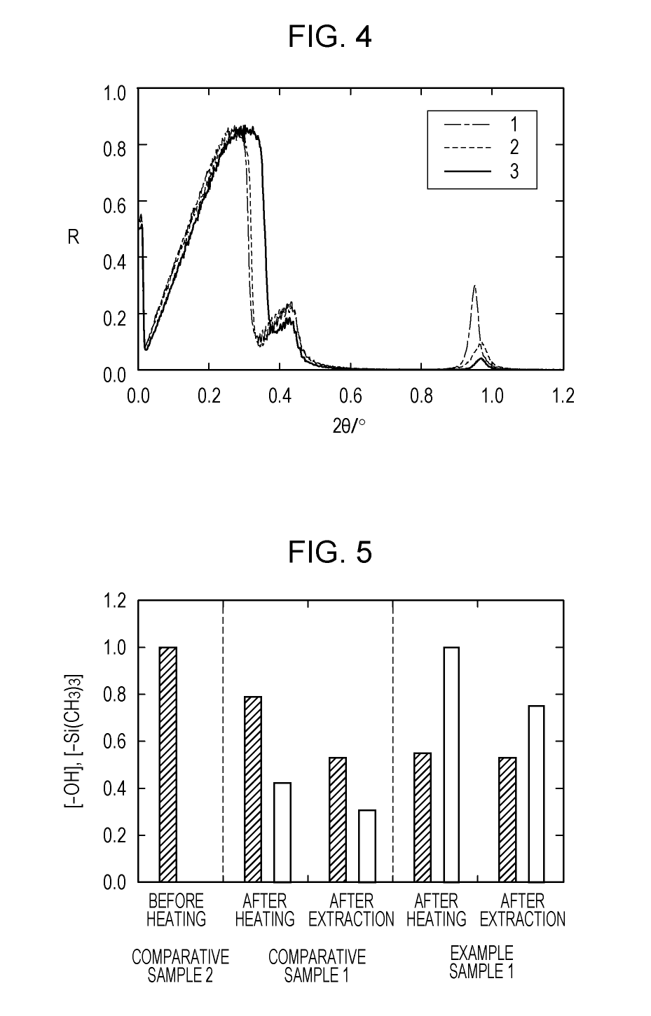

FIG. 4 is a graph comparing samples prepared in this example. In this graph, the abscissa represents the angle (2θ) between an incident X-ray and a detector and the ordinate represents reflectivity (relative value). In this graph, a curve depicted by numeral 1 corresponds to Example Sample 1, a curve depicted by numeral 2 corresponds to Comparative Sample 1, and a curve depicted by numeral 3 corresponds to Comparative Sample 2.

Example Sample 1 has a larger Bragg reflection peak due to a (01) plane parallel to a substrate as compared with Comparative Samples 1 and 2. The angle of the Bragg reflection peak of Example Sample 1 is smaller than that of each of Comparative Samples 1 and 2. The half-width of the Bragg reflection peak of Example Sample 1 is smaller than that of each of Comparative Samples 1 and 2.

This confirms that a mesoporous film-producing method of this example does not reduce structural period during the removal of a template, prevents shrinkage in a thickness direction, and is capable of producing a mesoporous film with increased structural period in some cases.

Furthermore, this confirms that a mesoporous film of this example has a high Bragg reflection intensity of more than 20% and high structural period, which is expressed by the half-width of a small Bragg reflection peak. The high Bragg reflection intensity thereof is accomplished by the increase in contrast of the refractive index due to the removal of a surfactant.

IR measurement was performed for the purpose of investigating the cause of the effect of a treatment method on an X-ray reflectivity profile, whereby information about the amount of hydroxyl groups and the amount of trimethylsilyl groups of each film was obtained.

FIG. 5 is a graph comparing the measurement results. In this graph, the ordinate represents the amount of hydroxyl groups and the amount of trimethylsilyl groups, a hatched bar indicates the amount of hydroxyl groups, and an empty bar indicates the amount of trimethylsilyl groups.

The term “the amount of hydroxyl groups” as used herein means the normalized integral of the absorbance in the wavenumber range of 3,150 cm⁻¹ to 3,750 cm⁻¹, which corresponds to a hydroxyl group, in an IR spectrum. The term “the amount of trimethylsilyl groups” as used herein means the normalized integral of the absorbance in the wavenumber range of 830 cm⁻¹ to 880 cm⁻¹, which corresponds to a trimethylsilyl group, in an IR spectrum. References for normalization are as follows: the amount of trimethylsilyl groups in an untreated sample is 1 and the amount of trimethylsilyl groups in a sample, treated with chlorotrimethylsilane, having a template is 1.

Example Sample 1 contains a larger amount of trimethylsilyl groups and a reduced amount of hydroxyl groups as compared with Comparative Samples 1 and 2. The removal of a template hardly varies the amount of the hydroxyl groups in Example Sample 1. These confirm that the amount of hydroxyl groups contributing to condensation can be effectively reduced by a producing method of this example.

### Example 2

In this example, the influence of changes in conditions for producing a mesostructured film on an X-ray diffraction pattern is considered. In this example, for Example Sample 1 prepared using only tetraethoxysilane as a silicon source during the preparation of a mesostructured film and Comparative Sample 3 prepared using tetraethoxysilane and ethoxytrimethylsilane during the preparation of a mesostructured film, the above-mentioned relationship between A and B is described. Sample conditions are as described below.

Example Sample 1 (the Same as that Disclosed in Example 1)

Comparative Sample 3

Differences of Comparative Sample 3 from Example Sample 1 are two items below.

1. A mesostructured film was prepared in such a manner that three mole percent of the amount of tetraethoxysilane was replaced with ethoxytrimethylsilane.

2. No reagent was used for treatment and heating was performed.

Table 1 shows the relationship between A and B obtained from results of the X-ray measurement of each sample.

TABLE 1

| | | | (Absolute | Normalized |
|---|---|---|---|---|
| | | | value of | structural |
| Samples | A (°) | B (°) | A/B) | periodicity |
| Example Sample 1 | −0.613 | 0.992 | 0.62 | 1.03 |
| Comparative Sample 3 | −0.618 | 1.07 | 0.58 | 0.91 |

Table 1 confirms that Example Sample 1 satisfies the following inequality:

$$\vert \frac{A}{B} \vert > 0.6 \qquad ( 2 )$$

This means that no shrinkage occurs in a thickness direction in a template-removing step. On the other hand, Comparative Sample 3 does not satisfy Inequality (2). This means that shrinkage occurs in a template-removing step. The shrinkage can be confirmed from the value of normalized structural period ((structural period after template-removing step)/(structural period before reagent treatment)).

This suggests that even if a material producing a trimethylsilyl group is used as a source material of a silicon oxide film to increase the number of trimethylsilyl groups in the silicon oxide film, a large number of unreacted silanol groups remain in a mesostructured film and the mesostructured film shrinks in the thickness direction thereof during the removal of a template.

It is difficult for Comparative Sample 3 to have high structural regularity and Bragg reflection intensity because of shrinkage and a reduction in structural regularity due to shrinkage.

### Example 3

In this example, the absorbance of a trimethylsilyl group determined by IR measurement is considered, the absorbance thereof being normalized with the value of a peak corresponding to a Si—O—Si bond. Sample conditions are as described below.

Example Sample 1 (the Same as that Disclosed in Example 1)

Comparative Sample 1

Difference of Comparative Sample 1 from Example Sample 1: the use of methoxytrimethylsilane as a treatment reagent

Comparative Sample 2

Difference of Comparative Sample 2 from Example Sample 1: no reagent treatment, non-heating, or no template removal (the remaining of a surfactant)

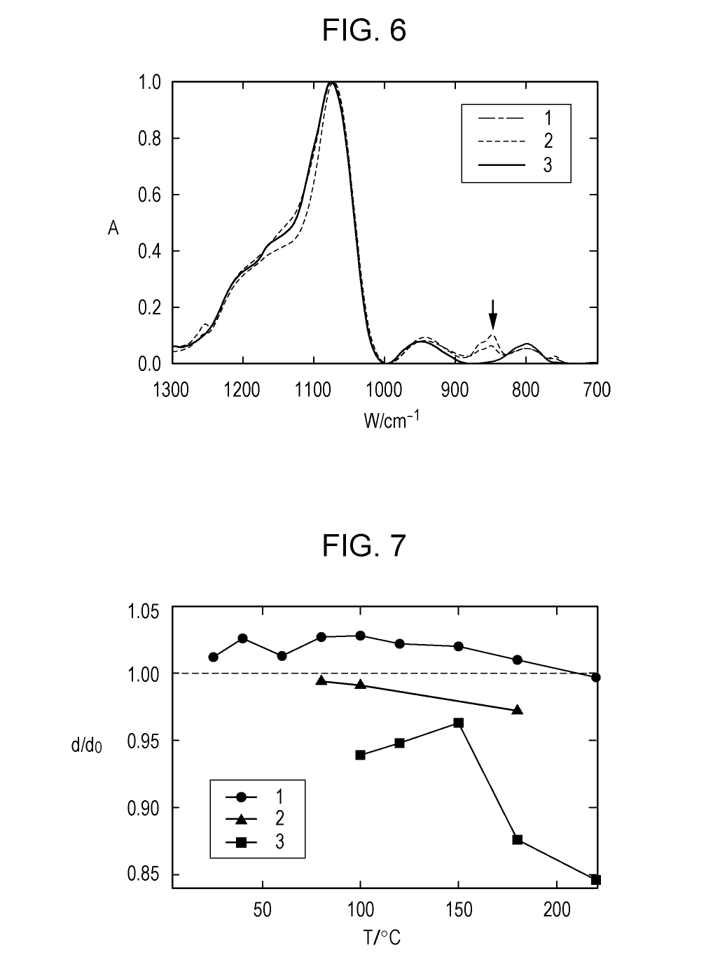

FIG. 6 is a graph comparing samples prepared in this example. In this graph, the abscissa represents the wavenumber and the ordinate represents the normalized absorbance. In this graph, a curve depicted by numeral 1 corresponds to Example Sample 1, a curve depicted by numeral 2 corresponds to Comparative Sample 1, and a curve depicted by numeral 3 corresponds to Comparative Sample 2.

A mesoporous film of this example has a maximum absorbance of 0.08 or more (0.10) at a wavenumber of 845 cm⁻¹±5 cm⁻¹ as normalized on the basis of the maximum absorbance at a wavenumber of 1,070 cm⁻¹±5 cm⁻¹. On the other hand, a mesoporous film of Comparative Sample 2 has a maximum absorbance of less than 0.08 (0.063) at a wavenumber of 845 cm⁻¹±5 cm⁻¹ as normalized on the basis of the maximum absorbance at a wavenumber of 1,070 cm⁻¹±5 cm⁻¹. This is explained by the difference in reactivity between a chloride used for Example Sample 1 and an alkoxide used for Comparative Sample 2.

### Example 4

In this example, the effect of a treatment reagent on normalized structural period is considered. The influence of different treatment reagents on normalized structural period is described using chlorotrimethylsilane used for Example Sample 1 as a reference. The treatment reagents are shown in Table 2. Table 2 describes the effect of a treatment reagent on the normalized structural period of each sample.

TABLE 2

| | | Normalized |
|---|---|---|
| | | structural |
| | Treatment reagents | periodicity |
| Example samples | Chlorotrimethylsilane | 1.03 |
| | (Example Sample 1) | |
| | Chloro-n-butyldimethylsilane | 1.00 |
| | Chloro-n-decyldimethylsilane | 1.00 |
| Comparative | Methoxytrimethylsilane | 0.994 |
| samples | Chloro-n-octadecydimethylsilane | 0.990 |
| | Bromotrimethylsilane | 0.989 |
| | Dichlorodimethylsilane | 0.988 |
| | Methyltrichlorosilane | 0.963 |

Table 2 confirms that samples of this example exhibit a larger normalized structural period as compared with comparative samples and are effectively prevented from shrinking and also confirms that a reagent, used for treatment, having an alkyl chain with ten or less carbon atoms and a reaction reagent containing a silicon atom and a chlorine atom bonded thereto are effective.

### Example 5

In this example, the effect (comparison between treatment reagents) of treatment temperature on normalized structural period is considered. Furthermore, in this example, the influence of different treatment reagents and different treatment temperatures on normalized structural period is described using Example Sample 1 of Example 1 as a reference. Treatment reagents used and treatment temperature are as described below.

Treatment temperature: 25° C. to 220° C.

Treatment reagents:

Chlorotrimethylsilane (as an example sample)

Methoxytrimethylsilane (as a comparative sample)

Not used (temperature treatment only) (as a comparative sample)

FIG. 7 is a graph comparing samples prepared in this example. In this graph, the abscissa represents the temperature and the ordinate represents the normalized structural period. In this graph, a line depicted by numeral 1 corresponds to a sample prepared using chlorotrimethylsilane as a treatment reagent, a line depicted by numeral 2 corresponds to a sample prepared using methoxytrimethylsilane, and a line depicted by numeral 3 corresponds to a sample prepared using no treatment reagent (temperature treatment only).

This graph confirms that a sample of this example exhibits a larger normalized structural period in every temperature range as compared with a sample, untreated with any treatment reagent, for comparison and a sample, treated with an alkoxide, for comparison and is effectively prevented from shrinking.

### Example 6

In this example, the effect of treatment time on normalized structural period is considered. Furthermore, in this example, the influence of a change in treatment time on normalized structural period is described using Example Sample 1 as a reference. Treatment time is as described in Table 3.

TABLE 3

| | | Normalized |
|---|---|---|
| | Treatment | structural |
| Samples | time (h) | periodicity |
| Comparative sample | 0 (not treated) | Unmeasurable |
| Example samples | 0.0028 | 1.01 |
| | 0.17 | 1.00 |
| | 0.5 | 0.99 |
| | 1 | 0.99 |
| | 2 | 0.99 |
| | 3 | 1.00 |
| | 6 | 1.00 |
| | 14 | 1.03 |
| | 60 | 1.01 |

A film of a sample (not treated) with a treatment time of 0 was dissolved during solvent extraction and therefore was lost. Table 3 confirms that samples of this example are effectively prevented from shrinking in every time range.

### Example 7

In this example, the extensibility of a surfactant is considered. Furthermore, in this example, the influence of different surfactants used for mesostructured films on normalized structural period is described using Example Sample 1 as a reference. Sample conditions are as described below.

Comparative Sample 2

Difference of Comparative Sample 2 from Example Sample 1: the use of a method of preparing a mesostructured film using the polyethylene oxide alkyl ether described in Section (1-1-2) as a template

Table 4 shows normalized structural periods obtained using different surfactants. Table 4 confirms that a producing method of this example effectively prevents the shrinkage of a sample prepared using the polyethylene oxide alkyl ether, thereby confirming the extensibility of a surfactant.

TABLE 4

| | | Normalized |
|---|---|---|
| | | structural |
| Samples | Surfactants | periodicity |
| Example | Polyethylene oxide- | 1.03 |
| Sample 1 | polypropylene oxide- | |
| | polyethylene oxide | |
| Example | Polyethylene oxide | 1.08 |
| Sample 2 | alkyl ether | |

### Example 8

In this example, the effect of template-removing conditions on normalized structural period is considered. Furthermore, in this example, two items below are described using Example Sample 1 as a reference.

1. Influence of different extraction solvents on normalized structural period

2. Influence of different template-removing methods (firing) on normalized structural period

### 1. Influence of Different Extraction Solvents on Normalized Structural Period

Sample conditions are as described below.

Example Sample 1

Example Sample 3

Difference of Example Sample 3 from Example Sample 1: the use of a tetrahydrofuran as an extraction solvent

Table 5 shows the influence of extraction solvents on normalized structural period. Table 5 confirms that a producing method of this example effectively prevents the shrinkage of a sample prepared using tetrahydrofuran, thereby confirming the extensibility of an extraction solvent.

TABLE 5

| | | Normalized |
|---|---|---|
| | Extraction | structural |
| Samples | solvents | periodicity |
| Example Sample 1 | Ethanol | 1.03 |
| Example Sample 3 | Tetrahydrofuran | 1.00 |

### 2. Influence of Different Template-Removing Methods (Firing) on Normalized Structural Period

Sample conditions are as described below.

Example Sample 4

Difference of Example Sample 4 from Example Sample 1: the use of firing as described in Section (1-3) as a template-removing method

Comparative Sample 4

Difference of Comparative Sample 4 from Example Sample 4: the use of methoxytrimethylsilane as a treatment reagent

Table 6 shows the influence of treatment reagents used in a template-removing method different from extraction on normalized structural period. Table 6 confirms that Example Sample 4 exhibits a larger normalized structural period as compared with Comparative Sample 4 and a producing method of an example of the present invention effectively prevents shrinkage even if a template-removing method is changed.

TABLE 6

| | Template- | | Normalized |
|---|---|---|---|
| | removing | | structural |
| Samples | condition | Treatment reagents | periodicity |
| Example | Firing | Chlorotrimethylsilane | 0.98 |
| Sample 4 | | | |
| Comparative | Firing | Methoxytrimethylsilane | 0.94 |
| Sample 4 | | | |

### Example 9

In this example, the applicability to an oxide other than silicon oxide is considered. Furthermore, in this example, the titanium oxide mesostructured film described in Section (1-1-3) is used as an example using an oxide other than silicon oxide. The influence of different reagents used to treat this film on the normalized structural period thereof is described. Sample conditions are as described below.

Example Sample 5

Difference of Example Sample 5 from Example Sample 1: the use of the titanium oxide mesostructured film described in Section (1-1-3) as a mesostructured film

Comparative Sample 5

Difference of Comparative Sample 5 from Example Sample 5: the use of methoxytrimethylsilane as a treatment reagent

Table 7 shows normalized structural periods obtained in Example 9. Table 7 confirms that a producing method of this example effectively prevents the shrinkage of a sample prepared using titanium oxide.

TABLE 7

| | | | Normalized |
|---|---|---|---|
| | | | structural |
| Samples | Oxides | Treatment reagents | periodicity |
| Example | Titanium | Chlorotrimethylsilane | 0.93 |
| Sample 5 | oxide | | |
| Comparative | Titanium | Methoxytrimethylsilane | 0.87 |
| Sample 5 | oxide | | |

### Example 10

In this example, the influence of treatment reagents on normalized structural period in the case of changing a reagent-treating method is considered. Sample conditions are as described below.

Example Sample 6

Difference of Example Sample 6 from Example Sample 1: the use of dipping treatment as described in Section (1-2) as a reagent-treating method

Comparative Sample 6

Difference of Comparative Sample 6 from Example Sample 6: the use of methoxytrimethylsilane as a treatment reagent

Table 8 shows normalized structural periods obtained in Example 10. Table 8 confirms that Example Sample 6 exhibits a larger normalized structural period as compared with Comparative Sample 6 and is effectively prevented from shrinking. This proves that a producing method of this example functions effectively even if a reagent-treating method is changed.

TABLE 8

| | | | Normalized |
|---|---|---|---|
| | | | structural |
| Samples | Treatment reagents | Treatment | periodicity |
| Example | Chlorotrimethylsilane | Immersion | 1.02 |
| Sample 6 | | | |
| Comparative | Methoxytrimethylsilane | Immersion | 0.98 |
| Sample 6 | | | |

Preferred embodiments of the present invention have been described above. The present invention is not limited to these embodiments. Various modifications and variations can be made within the scope of the present invention.

Technical elements described herein or with reference to the attached drawings exhibit technical utility alone or in combination and are not limited to combinations described in Claims as filed. Techniques described herein or with reference to the attached drawings simultaneously achieve a plurality of objects and have technical utility by achieving one of the objects.

A method of producing a mesoporous film according to the present invention can prevent the shrinkage of the mesoporous film during the removal of a template particularly in the thickness direction thereof and the reduction in structural regularity of the mesoporous film due to the shrinkage. Since the shrinkage of the mesoporous film is prevented in the thickness direction thereof, the mesoporous film exhibits high structural regularity.

The effect of preventing the shrinkage of the mesoporous film particularly in the thickness direction thereof allows the mesoporous film to have, for example, high specific surface area, low dielectric constant, low refractive index, and the like. Therefore, the mesoporous film is useful for industrial applications making use of such properties.

In particular, the mesoporous film can be used for applications below.

Applications, such as catalysts and electrodes for electrochemical devices including batteries, making use of high specific surface area

Applications, such as optical devices including antireflective films, making use of low refractive index

Applications, such as low-dielectric constant materials for electronic devices, making use of low dielectric constant

Applications, such as X-ray mirrors, making use of high structural regularity

According to a method of producing a mesoporous film according to the present invention, the shrinkage of the mesoporous film can be reduced during the removal of a template.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-260529 filed Nov. 22, 2010, which is hereby incorporated by reference herein in its entirety.

What is claimed is:

1. A method of producing a mesoporous film, comprising:
a step of preparing a mesostructured film containing a surfactant and an inorganic oxide;
a step of holding the mesostructured film in an atmosphere containing a compound having the following formula; and
a step of removing the surfactant from the mesostructured film during and/or subsequently to the holding step: 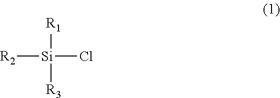
wherein R₁, R₂, and R₃ independently represent an alkyl group containing ten or less carbon atoms.

2. The method according to claim 1, wherein R₂ is an alkyl group containing ten or less carbon atoms and R₂ and R₃ are methyl groups.

3. The method according to claim 1, wherein R₁, R₂, and R₃ are methyl groups.

4. The method according to claim 1, wherein the mesoporous film has a periodic structure.

5. The method according to claim 4, wherein the periodic structure is a structure in which cylindrical pores are arranged in a honeycomb pattern.

6. The method according to claim 1, wherein the oxide is silicon oxide or titanium oxide.

7. The method according to claim 1, wherein in the surfactant-removing step, the surfactant is removed from the mesostructured film by a solvent extraction technique.

8. A mesoporous film formed on a substrate, having a periodic structure and the plane which consists of the periodic structure, which is parallel to a surface of the substrate, and which has a maximum Bragg reflectivity of more than 20% to less than 60% as measured by X-ray diffraction with a 20 resolution of 0.034 degree or less using Bragg-Brentano geometry and an incident X-ray with a divergence angle of 3.4×10⁻³ degree or less.

9. The mesoporous film according to claim 8, further having a mesostructure in which cylindrical pores are arranged in a honeycomb pattern, wherein the following inequality is satisfied:
$$\vert \frac{A}{ B} \vert > 0.6 \qquad ( 2 )$$
where A is the peak angle of Bragg reflection due to the (10) plane in the in-plane direction of the substrate in X-ray diffraction and B is the peak angle of Bragg reflection due to the (01) plane in the out-of-plane direction of the substrate in X-ray diffraction.

10. A mesoporous silicon oxide film formed on a substrate, having a maximum absorbance of 0.08 or more at a wavenumber of 845 cm⁻¹±5 cm⁻¹ as normalized on the basis of the maximum absorbance at a wavenumber of 1,070 cm⁻¹±5 cm⁻¹ in an infrared region, the mesoporous silicon oxide film having a structure in which cylindrical pores are arranged in a honeycomb pattern, wherein the following inequality is satisfied:
$$\vert \frac{A}{B} \vert > 0.6 \qquad ( 2 )$$
where A is the peak angle of Bragg reflection due to the (10) plane in the in-plane direction of the substrate in X-ray diffraction and B is the peak angle of Bragg reflection due to the (01) plane in the out-of-plane direction of the substrate in X-ray diffraction.
